(19) United States
(12) Patent Application Publication
(10) Pub. No.: US 2017/0036599 A1
(43) Pub. Date: Feb. 9, 2017

(54) VEHICLE DISPLAY AND MIRROR

(71) Applicant: Ford Global Technologies, LLC, Dearborn, MI (US)

(72) Inventors: Adil Nizam SIDDIQUI, Farmington Hills, MI (US); Brad Alan IGNACZAK, Canton, MI (US)

(21) Appl. No.: 14/819,559

(22) Filed: Aug. 6, 2015

(51) Int. Cl. B60R 1/00; H04N 5/235; H04N 5/232; H04N 7/18

(52) U.S. Cl. CPC B60R 1/00; B60R 1/006; H04N 7/183; H04N 5/2351; H04N 5/23293; B60R 2300/20; B60R 2300/802

(57) ABSTRACT

A vehicle includes an interface and a controller. The interface is supported by a structural member of the vehicle and configured to display video output from a camera. The controller is configured to, in response to an error associated with the camera, move the interface to a predetermined position to change a field of view of a vicinity of the vehicle and reflected by the interface.

### TECHNICAL FIELD

The present disclosure relates to interfaces attached vehicles.

### BACKGROUND

Vehicles may be equipped with cameras to aid in detecting objects within a vehicle blind spot. The cameras detect an image and send the image input to a controller. The controller processes the image and fits the image to an interface. The interface may be attached to an interior of a vehicle, such as on an A-pillar. A driver may then use the image on the interface to aid in changing lanes while traveling. The interface may also be attached to an exterior of the vehicle, such as to a side-view mirror of the vehicle.

### SUMMARY

An information display system for a vehicle includes an interface and a controller. The interface is supported on a side of the vehicle and configured to display output from a camera. The controller is configured to, in response to a display anomaly, stop displaying the output and move the interface to a predetermined position to increase a field of view associated with the side of the vehicle and reflected by the interface.

A control method for an information system of a vehicle includes, in response to a fault message associated with a camera, moving by a controller an interface configured to display output from the camera to a predetermined position selected to increase a field of view next to the vehicle and reflected by the interface for a driver of the vehicle.

A vehicle includes an interface and a controller. The interface is supported by a structural member of the vehicle and configured to display video output from a camera. The controller is configured to, in response to an error associated with the camera, move the interface to a predetermined position to change a field of view of a vicinity of the vehicle and reflected by the interface.

### BRIEF DESCRIPTION OF THE DRAWINGS

FIG. 1 is a top view of a vehicle;

FIG. 2 is a perspective view of a vehicle interior having an interface attached to the A-pillar;

FIG. 3 is a system diagram showing inputs and outputs of a controller; and

FIG. 4 is a flow diagram of a control system for an interface mirror.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Referring to FIG. 1, a vehicle 10 is shown having side mirrors 12 and sensors 14 disposed on side panels 16 of the vehicle 10. The sensors 14 may have a field-of-view, or line-of-sight 18 directed adjacent with the side panels 16. The line-of-sight 18 is consistent with a typical blind spot of the vehicle 10. A vehicle blind spot occurs when the side mirrors 12 do not reflect the entirety of the side panels 16 of the vehicle. 10. The sensors 14 aid a driver in detecting the presence of an object within the blind spot. This further aids the driver when operating the vehicle 10 and making a lane change. If the sensors 14 become occluded, or blocked, the driver may still use the side mirrors 12 to check the blind spot before making a lane change.

The sensors 14 may be configured to communicate with the driver using an information display system 20 within the vehicle 10. For example, the sensors 14 may be a camera configured to communicate a video signal to the interface 22 on a center console 24 of the vehicle 10. The interface 22 may also be attached to a structural member 26 on an interior 28 of the vehicle 10. For example, the interface 22 may be attached to an A-pillar. Attaching the interface 22 to the A-pillar on the interior 28 of the vehicle 10 allows the driver a natural location to view the video feed from the camera 14 to determine if an object is present in the blind spot of the vehicle 10. If the camera 14 is blocked or occluded, the interface 22 may only be able to show a limited area of the blind spot. If the camera 14 is damaged or has lost communication with the interface 22, the interface 22 may only provide a blank image. When the camera 14 is either blocked or damaged, the side mirrors 12 may still provide a passive system for detecting an object in the blind spot.

Typically, side mirrors 12 extend perpendicular to the side panels 16 of the vehicle 10. This allows the side mirrors 12 to reflect images from the blind spot adjacent the side panels 16. By extending perpendicular to the vehicle side panels 16, the side mirrors 12 create aerodynamic drag as the vehicle 10 travels. Aerodynamic drag of the side mirrors 12 reduces the overall fuel economy of the vehicle 10. Also, by being on the exterior of the vehicle 10, the side mirrors 12 are more susceptible to external contaminants, such as dirt or damage. An information display system 20 that includes the advantages of using a camera 14 and the interface 22 while accounting for camera blockage to eliminate the side mirrors 12 may be advantageous.

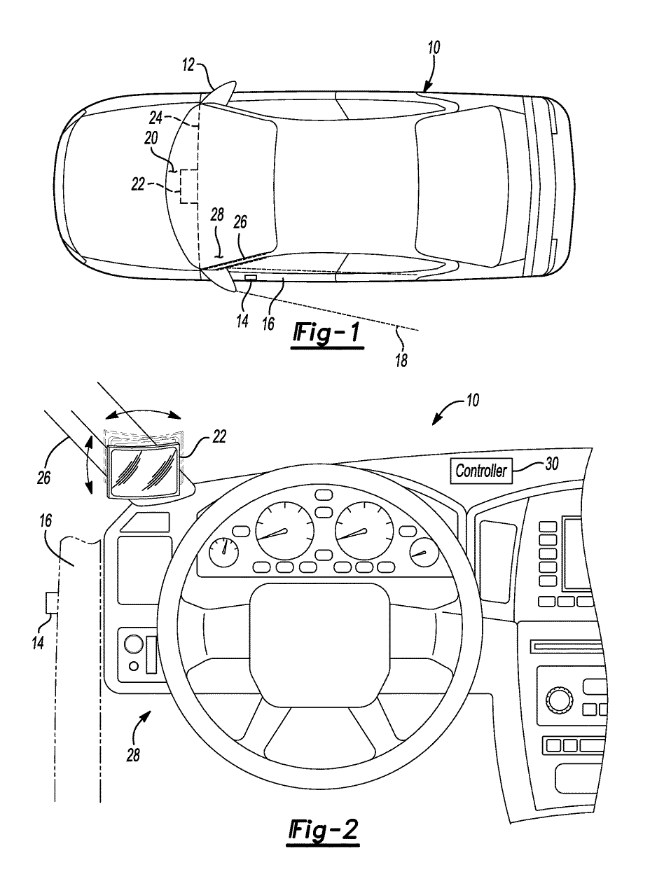

Referring to FIG. 2, the interface 22 is shown in a perspective view attached to the structural member 26 on the interior 28 of vehicle 10. Although depicted in FIG. 2 as a single interface 22 on a driver side of the vehicle 10, a second interface 22 may also be attached to the structural member 26 on a passenger side of the vehicle 10. In at least one embodiment, the interface 22 may be formed having a convex shape. The interface 22 may also embody other shapes, such as flat, concave, or any other shape that would allow the interface 22 to reflect an image of the exterior side panels 16. The interface 22 may also be formed using a material having a high reflectance. In at least one embodiment, the interface 22 may be formed from dielectric glass, or any other material having a high reflectance allowing the interface to act as a mirror. By embodying a shape that provides an advantageous angle for viewing the exterior side panel 16 and using material having a high reflectance, such as dielectric glass, the interface 22 may be used as a replacement for the side mirrors (not shown).

For example, a camera 14 disposed on side panels 16 may send a video feed input signal to a controller 30. The controller 30 may be configured to segment the image from the camera 14 and fit the image to the interface 22. Providing a video feed input signal to the interface 22 provides the driver with a real-time indication of an object's presence in the vehicle's blind spot. The controller 30 may also be configured to provide the video feed input signal to the interface 22 when the driver activates a turn signal and while the vehicle is moving at a constant speed. The controller 30 may be configured to receive inputs from a vehicle speed sensor (not shown) as well as determine activation of a turn signal (not shown). If the vehicle 10 is moving at a constant speed and the turn signal is activated, the controller 30 may determine that the driver is making a lane-change maneuver. These inputs allow the controller 30 to determine whether the video feed input signal from the camera 14 should be segmented to the interface 22. As will be discussed in more detail below, the interface 22 may also provide other functionality, such as GPS mapping to the driver. If a driver does not indicate a lane change maneuver, then the controller 30 may use the interface 22 for other functions, such as GPS mapping. The controller 30 may be an external vehicle controller 30 or a controller 30 integral with the camera 14.

If the vehicle 10 is moving at a constant speed and the driver activates a turn signal indicating a lane change maneuver, the controller 30 may also be configured to determine a display anomaly. A display anomaly occurs when the camera 14 has a blocked or distorted line-of-sight to the vehicle blind spot. The controller 30 may determine a blocked or distorted line-of-sight to the vehicle blind spot if, within a predetermined time, nothing within the camera 14 viewpoint changes or if the brightness of the video input signal is less than a threshold value. In at least one other embodiment, the camera 14 may also be configured to determine a display anomaly. If the camera 14 determines a blockage within the line-of-sight, the camera 14 may send a fault message to the controller 30 indicating activation of a display anomaly. If the controller 30 determines that the line-of-sight to the vehicle blind spot is blocked or distorted, or receives a fault message from the camera 14, then the controller 30 may configure the interface 22 to provide high reflectance. Using the example of a dielectric glass interface 22, the controller 30 configures the interface 22 to provide high reflectance by changing a current applied to the interface 22.

The controller 30 may also be configured to automate adjustment of the interface 22 based on a set of predetermined characteristics. For example, in the event of a display anomaly, the interface 22 may be angled or rotated to further provide a larger field-of-view of the vehicle side panels 16 allowing the driver to check the vehicle blind spot. The controller 30 may command the interface 22 to automatically move into a preset position upon detection of a camera failure. Automatically moving the interface 22 allows further detection of an object in the vehicle's blind spot. The preset position of the interface 22, in the event of the display or camera anomaly, may be optimized based on the curvature of the interface 22, size of the vehicle 10, and characteristics of the driver. In at least one other embodiment, the interface 22 may be configured to be manually moved to a driver's preference during a display anomaly for blind spot detection.

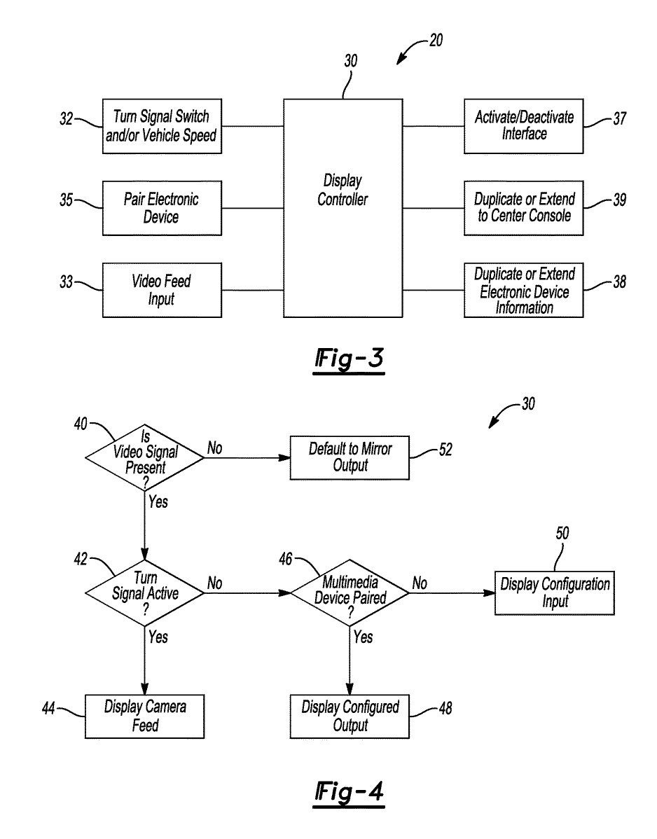

Referring to FIG. 3, a control system diagram for the controller 30 is shown. The information display system 20 uses inputs to the controller 30 that allow the controller 30 to provide outputs to display an interior mirror on the interface 22, as discussed above. For example, at 32 a vehicle speed signal and turn signal activation signal may be input into the controller 30. At 32, the vehicle speed signal and activation of the turn signal indicate the driver is performing a lane-change maneuver. The camera 14 may provide a video feed input signal at 33 to the controller 30. The video feed input signal at 33 may be input to the controller 30 in which the controller 30 processes the signal to determine if the camera is blocked or damaged.

At 35, if the driver or the passenger is using an electronic device 34, the controller 30 receives an input signal to pair the electronic device 34 with the interface 22. The electronic device 34 is paired with the interface using a Bluetooth connection. In at least one other embodiment, the electronic device 34 is paired with the interface 22 using near-field communication, or a Wi-Fi network. Pairing between an electronic device 34 and the controller 30 improves functionality of the interface and will be discussed in more detail below.

After receiving the input signals, the controller 30 outputs commands to the information display system 20. For example, after receiving input signals such as the video feed input signal from the camera 14, a turn signal activation input signal, or both, the controller 30 may activate the interface 22 at 37. Activation of the interface may include outputting the video signal from the camera 14 to the interface 22. After processing, if the controller 30 determines a display anomaly of the camera 14, the controller 30 may also deactivate at 37 the interface to provide a reflection of the vehicle side panels 16 to check the vehicle blind spot. After receiving an input signal to pair electronic device 34 with the interface 22, the controller 30 may either extend at 38 information from the electronic device 34 to the interface 22 or duplicate at 38 information from the electronic device 34 to the interface 22 via Bluetooth. The controller 30 may also be configured to extend or duplicate information from the electronic device 34 to a center console at 39.

The input and output commands allow the controller 30 to use the interface 22 in place of the side mirrors 12. Configuring the interface 22 to reflect the field-of-view substantially similar to that of the side mirrors 12 allows the interface 22 to provide a passive information display system 20 in which the interface 22 acts as a mirror to provide the driver with vehicle blind spot information. The information display system 20 may also be multi-functional. For example, the information display system 20 may be configured to pair with electronic device 34 such as a GPS system and display the GPS information on the interface 22. Providing both active and passive information display systems 20 using a single interface 22 allows for elimination of the side mirrors 12. Elimination of side mirrors 12 provides for a more aerodynamic vehicle.

FIG. 4 represents a control system flow diagram representative of the information display system 20. The control logic shown in FIG. 4 may be employed through the controller 30 either as part of the camera 14, a separate controller 30, or as part of a larger vehicle system controller 30. FIG. 4 depicts the steps of the information display system 20 as being sequential, however the steps of the information display system 20 may be performed simultaneously, or in any other order which allows information display system 20 to be configured as described.

At 40, the controller 30 determines if a video input signal from the camera is present. This is consistent with image segmentation described above. For example, the controller 30 may analyze the image from the camera to determine any distortion in the video input signal at 40. Distortion of the video input signal at 40 may include a blockage or occlusion on the camera, or a failed video input signal from the camera indicative of damage to the camera. Distortion of the video input signal is consistent with the display anomaly described above. The controller 30 may determine that the camera is blocked or damaged by comparing at 40 frames of the video input signal to each other to determine movement within the camera field-of-view. Movement may be determined by vehicles moving in and out of the camera field-of-view, or by other indicators such as lane markings on the road.

The controller 30 may also determine that the camera is blocked or damaged at 40 by comparing brightness from the video input signal. For example, a sudden change in brightness to below a threshold may indicate a blockage or damage to the camera. Also, a threshold level of brightness may be determined by using an average brightness set by monitoring typical usage of the camera. The controller 30 may also account for brightness changes during normal vehicle usage, such as traveling through a tunnel or driving at night, when comparing the average brightness to the threshold.

If at 40, the controller 30 determines that a video input signal is present, the controller 30 checks if the turn signal has been activated at 42. If a turn signal has been activated, then the controller 30 may display the video input feed from the camera on the interface at 44. Outputting the video input feed from the camera on the interface allows the interface to provide a live video feed of the vehicle's blind spot at 44. Activation of the turn signal provides one example of an indication of a lane-change maneuver. Other indicators of a lane-change maneuver may include but are not limited to, the vehicle moving at a constant speed, a change of angle of a steering wheel within a predetermined threshold, or a decreasing distance to another vehicle parallel to the vehicle. If at 42, the turn signal has not been activated, the controller 30 checks to see if an electronic device has been paired with the interface at 46. If the turn signal has not been activated, or the controller has not received any other lane change maneuver indicators at 42, and an electronic device has been paired with the interface at 46, the controller outputs information from the electronic device to the interface at 48.

The information output from the electronic device to the interface at 48 may be either through screen extension or screen mirroring. If at 48 the controller 30 is configured to extend the screen of the electronic device to the interface, then the interface may be used to perform operations from the electronic device at 48 while the electronic device is being used for a different operation. For example, the interface may be used for data streaming while the electronic device may be used for web browsing. If the interface is being used for screen mirroring, then the data from the electronic device is streamed directly to the interface and the operator may use the interface in operation of the electronic device. Pairing the electronic device with the interface at 48 allows the information display system 20 to be multi-functional with electronic device.

If at 48 an electronic device is not paired with the interface, the controller 30 may be configured to output vehicle information to the interface based on either a predefined configuration or a user-defined configuration at 50. For example, the controller 30 may be configured to output information such as GPS location and mapping, the distance-to-empty fuel parameters, tire pressure information, or any other information indicative of important vehicle functions at 50. Likewise, the controller 30 may be configured to output information consistent with an infotainment system, such as but not limited to radio information, local attraction information, and weather information at 50. At 50, a user may also predefine the input configuration for the interface when the interface is not being used as a mirror replacement. For example, a user may desire GPS mapping and location data to be displayed on the interface under normal driving conditions. The user is able to configure the controller 30 to output GPS data including location and mapping information to the interface at 50.

Referring back to 40, if a video input signal from the camera is not present, then the controller 30 is configured to set the interface to have a reflective surface at 52. The controller 30 may configure the interface to be reflective in a variety of ways including, but not limited to, applying current to the interface in which current causes the interface to be reflective, or by powering off the interface if the interface is fabricated from a reflective material, such as dielectric glass. Configuring the interface to be reflective at 52 allows the interface to act as a mirror. Also, at 52 the controller 30, as stated above, may be configured to rotate and tilt the interface to further provide a field-of-view of the vehicle blind spot.

The interface attaches to an interior structural member, such as an A-pillar of the vehicle in a way that allows the interface to rotate and tilt at 52. This allows the interface, acting as a mirror, to provide a further field-of-view of the vehicle blind spot. The angle of rotation and degree of tilt of the interface at 52 may be preset and optimized based on characteristics of the interface, the vehicle, and the driver. Presetting the angle of rotation and degree of tilt at 52 allows the controller 30 to automate the process of using the interface as a mirror in the event of camera failure. Rotation and tilt of the interface may also be done manually. For example, driver characteristics, such as height, may require the interface be rotated and tilted different amounts. The interface may be configured to allow driver to adjust the angle of reflection to enhance the field-of-view of the interface by manually rotating and tilting the interface, or by using a switch, as in traditional vehicle side mirror movement. Configuring the interface to be reflective and allowing the interface to rotate and tilt allows the interface to act as a side mirror replacement and improve the aerodynamics of the vehicle.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary to embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An information display system for a vehicle comprising:
an interface supported on a side of the vehicle and configured to display output from a camera; and
a controller configured to, in response to a display anomaly, stop displaying the output and move the interface to a predetermined position to increase a field of view associated with the side of the vehicle and reflected by the interface.

2. The information display system of claim 1 wherein the display anomaly is in response to image segmentation indicating a blockage of the camera.

3. The information display system of claim 1 wherein the display anomaly is in response to image segmentation indicating a brightness being less than a threshold.

4. The information display system of claim 1 wherein the controller is disposed within the camera.

5. The information display system of claim 1 wherein the interface has a convex shape.

6. The information display system of claim 1 wherein the controller is further configured to, in response to activation of a turn signal, permit the interface to access the output from the camera.

7. A control method for an information system of a vehicle comprising:
in response to a fault message associated with a camera, moving by a controller an interface configured to display output from the camera to a predetermined position selected to increase a field of view next to the vehicle and reflected by the interface for a driver of the vehicle.

8. The control method of claim 7 further comprising generating the fault message in response to image segmentation indicating blockage of the camera.

9. The control method of claim 7 further comprising generating the fault message in response to image segmentation indicating a brightness being less than a threshold.

10. The control method of claim 7, wherein the camera is configured to capture an image of an exterior of the vehicle.

11. The control method of claim 7, wherein the interface has a convex shape.

12. A vehicle comprising:
an interface supported by a structural member of the vehicle and configured to display video output from a camera; and
a controller configured to, in response to an error associated with the camera, move the interface to a predetermined position to change a field of view of a vicinity of the vehicle and reflected by the interface.

13. The vehicle of claim 12 wherein the interface has a dielectric glass outermost layer.

14. The vehicle of claim 13 wherein the controller is further configured to alter a current applied to the interface.

15. The vehicle of claim 12 wherein the interface has a convex shape.

16. The vehicle of claim 12 wherein the predetermined position is user defined.

17. The vehicle of claim 12 wherein the error is in response to image segmentation indicating a blockage of the camera.

18. The vehicle of claim 12 wherein the error is in response to image segmentation indicating a brightness being less than a threshold.
